(19) United States
(12) Patent Application Publication
(10) Pub. No.: US 2012/0318549 A1
(43) Pub. Date: Dec. 20, 2012

(54) IMPACT TOOL

(75) Inventors: Hidenori NAGASAKA, Anjo-shi (JP); Takashi KIYOHARA, Anjo-shi (JP)

(73) Assignee: MAKITA CORPORATION, Anjo-shi (JP)

(21) Appl. No.: 13/456,675

(22) Filed: Apr. 26, 2012

(30) Foreign Application Priority Data
Jun. 15, 2011 (JP) 2011-133487

(51) Int. Cl. B25B 21/02; B25F 5/02

(52) U.S. Cl. 173/109

(57) ABSTRACT

In an impact tool, a hammer case into which an output shaft of a motor is inserted is assembled to the front of a housing containing a stator core. In the hammer case, a spindle to which rotation is transmitted from the output shaft of the motor is provided. The rear end of the hammer case is coupled with a bearing box. In the housing, a partition wall through which the output shaft passes is provided between the stator core side and the hammer case side. On the housing, an air inlet is provided. An electric circuit board is provided on the front face of the stator core to close the front face with the output shaft passing therethrough. Between the electric circuit board and the partition wall, a waterproof member through which the output shaft passes is provided to close the gap therebetween.

### BACKGROUND OF INVENTION

This application claims the entire benefit of Japanese Patent Application Number 2011-133487 filed on Jun. 15, 2011, the entirety of which is incorporated by reference.

### TECHNICAL FIELD

The present invention relates to an impact tool including a hammer case in the front of a housing containing a motor, the hammer case having an impact mechanism and the like installed therein.

### BACKGROUND ART

Japanese Patent Application Publication No. JP-A-2009-72867, for example, discloses a conventional impact driver enabling stable operation of a motor by effectively cooling a switching element of a circuit board. In the impact driver disclosed in the above-described Patent Application Publication, an air inlet is provided in a housing containing a motor to introduce cooling air for the motor and a ring-shaped air flow control rib is formed to extend toward the inside of the housing along the inner wall of the housing in the vicinity of the air inlet. In the impact driver disclosed in JP-A-2009-72867, the switching element is effectively cooled by the cooling air in such a manner that the air flow control rib causes the cooling air to pass in the vicinity of the switching element of the circuit board constituting the motor.

### SUMMARY OF INVENTION

However, when an impact tool such as the above-described conventional impact driver is left outside and the rain falls, for example, there have been some cases where rainwater or the like enters inside the housing from the air inlet. The rainwater or the like having entered inside the housing may enter inside the hammer case assembled in the front of the housing from a through hole for inserting the output shaft of the motor into the hammer case. If the rainwater or the like enters inside the hammer case, a bearing of a spindle receiving rotational transmission from the output shaft of the motor and the impact mechanism inside the hammer case may be malfunctioned.

The present invention has been developed in view of such a situation. An object of the present invention is to provide an impact tool including a hammer case with enhanced waterproof property, the hammer case having an impact mechanism and the like installed therein.

An impact tool according to a first aspect of the present invention includes a housing, a motor contained in the housing and including a stator core provided with a stator coil, and a hammer case assembled in the front of the housing to receive an output shaft of the motor inserted therein. A spindle is installed in the hammer case, and rotation is transmitted from the output shaft to the spindle. An impact mechanism is also installed in the hammer case and is capable of converting output from the spindle into an intermittent striking operation. A cover member is integrally coupled with a rear end of the hammer case, and the output shaft passes through the cover member. A partition wall is installed in the housing so as to partition the stator core side and the hammer case side, and the output shaft passes through the partition wall. An air inlet for cooling air for the motor is provided on a side face of the housing. A closing body is provided on a front face of the stator core to close the front face with the output shaft passing therethrough. A ring-shaped waterproof member is provided between the closing body and the partition wall to close a gap between the closing body and the partition wall with the output shaft passing therethrough.

According to a second aspect of the present invention, in addition to the first aspect, a ring-shaped bearing portion is provided on a rear face of the cover member so as to protrude toward the closing body side and hold a bearing rotatably supporting the output shaft, and the waterproof member is attached on the outer periphery of the bearing portion between the closing body and the partition wall.

According to a third aspect of the present invention, in addition to the first aspect, the closing body is an electric circuit board.

According to a fourth aspect of the present invention, in addition to the first aspect, an air intake is provided in the rear of the closing body in the stator core so that the cooling air introduced into the housing from the air inlet can be taken into the stator core.

According to the impact tool of the first aspect of the present invention, the ring-shaped waterproof member is provided so that rainwater or the like having entered inside the housing from the air inlet for the cooling air is prevented from entering inside the hammer case through a penetrating part of the output shaft of the motor, which is located on the cover member between the closing body and the partition wall. Accordingly, it is possible to enhance the waterproof property of the hammer case.

According to the second aspect of the present invention, the waterproof member can be easily positioned between the closing body and the partition wall simply by attaching the waterproof member on the outer periphery of the bearing portion.

According to the third aspect of the present invention, a rational structure is enabled in which the electric circuit board is also used as the closing body.

According to the fourth aspect of the present invention, even when the front face of the stator core is closed by the closing body, it is possible to cool the stator core from inside with the cooling air taken into the stator core from the air intake. Accordingly, the cooling effect of the motor can be enhanced.

### BRIEF DESCRIPTION OF DRAWINGS

FIG. 1 is a perspective rear view of an impact driver in a first embodiment of the present invention.

FIG. 2 is a longitudinal sectional view of the impact driver in FIG. 1.

FIG. 3 is a cross sectional view of the impact driver in FIG. 1.

FIG. 4 is a fragmentary longitudinal sectional view of a body housing containing a stator core with an air intake formed thereon.

FIG. 5 is an exploded perspective view of the body housing with a bearing portion of a bearing box protruding from a partition wall, a waterproof member, and a motor.

FIG. 6 is a perspective rear view of an impact driver with an air intake cover in a second embodiment attached thereon.

FIG. 7 is a side view of the impact driver in FIG. 6 with the air intake cover removed therefrom.

FIG. 8 is a side view of a half housing constituting a body housing of an impact driver in a third embodiment.

### DETAILED DESCRIPTION OF EMBODIMENTS

### First Embodiment

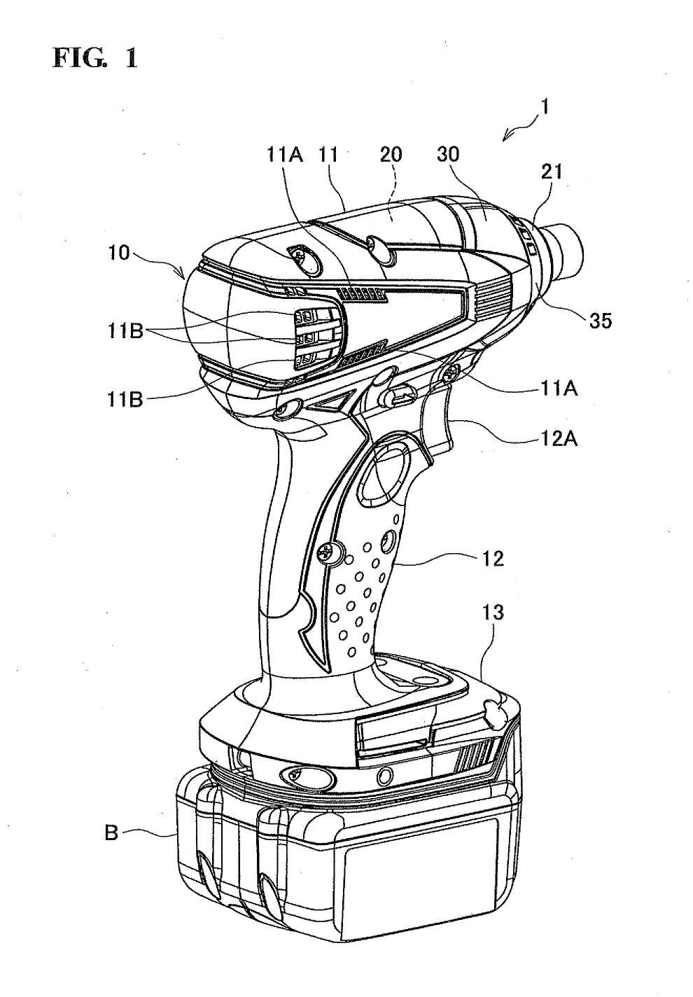

A first embodiment of the present invention will be described with reference to FIG. 1 to FIG. 5. As shown in FIG. 1 to FIG. 3, an impact driver 1 in the present embodiment includes a body housing 10, a hammer case 20, and a waterproof member 50. It should be noted that the impact driver 1 is an example of impact tools according to the present invention.

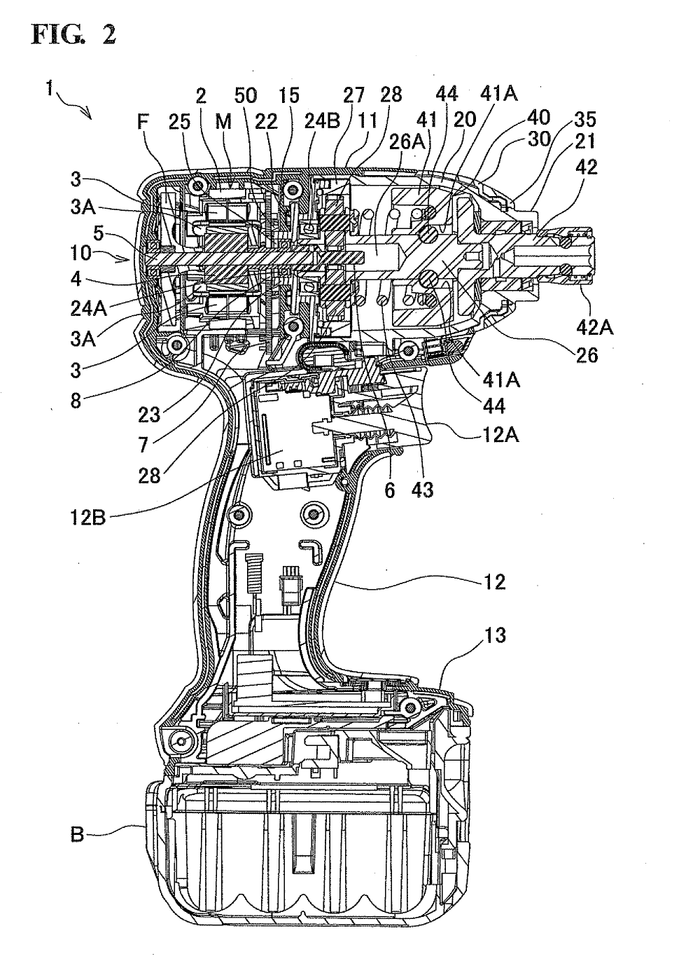

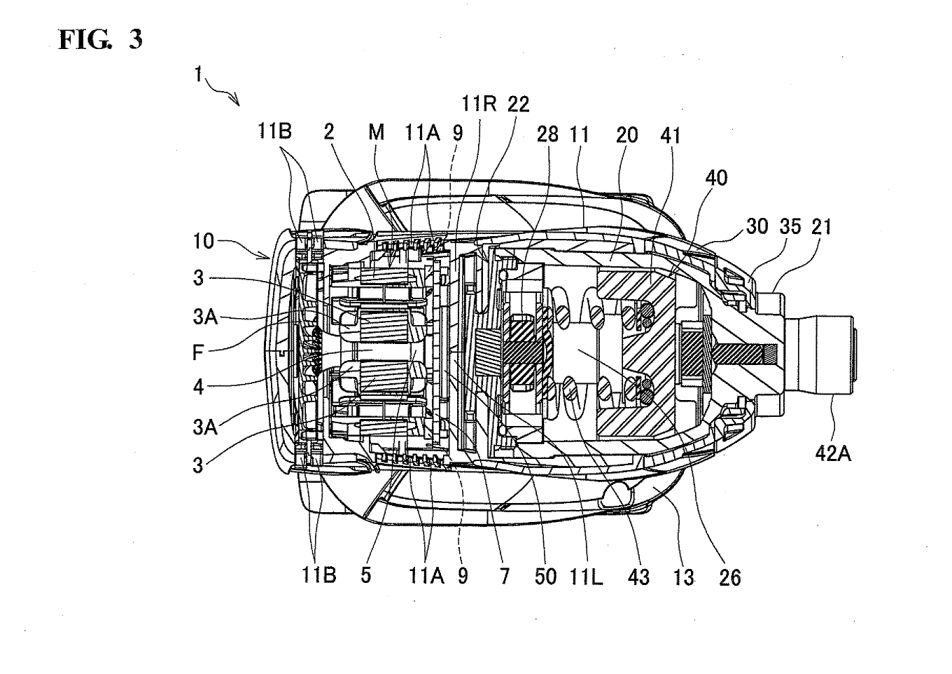

The body housing 10 is formed by assembling of a right half housing and a left half housing each made of resin and includes a body trunk portion 11, a handle portion 12, and a battery pack attachment portion 13. The body trunk portion 11 is tubular shaped and installed on the impact driver 1 in an extending manner in the front-rear direction (right-left direction in FIG. 2 and FIG. 3). A motor M is contained in the rear of the inside of the body trunk portion 11 (left section of FIG. 2 and FIG. 3).

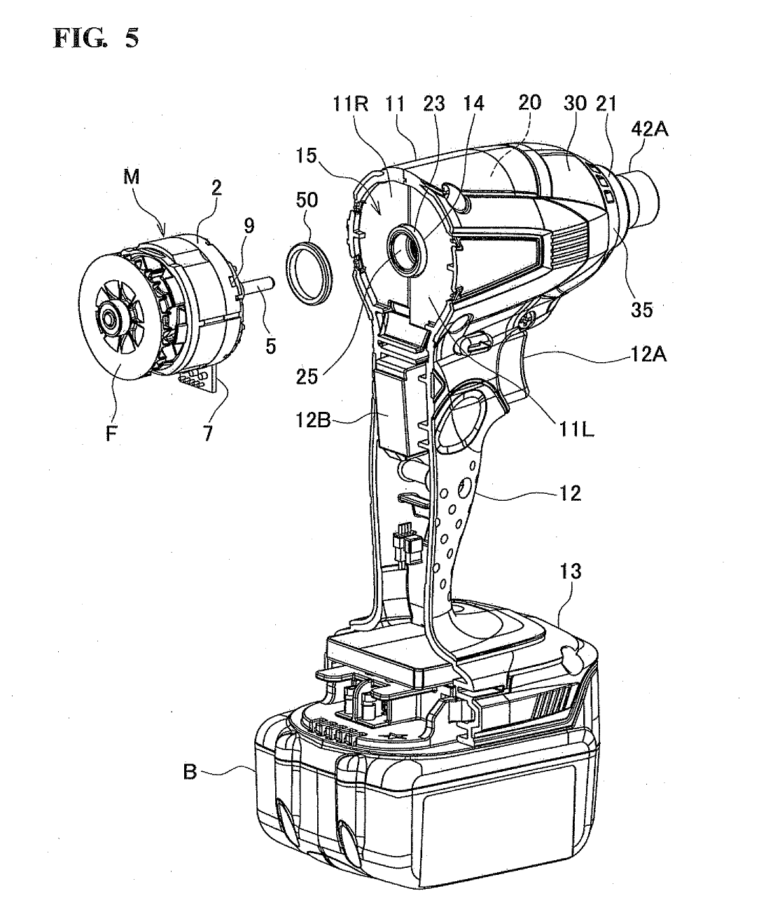

As shown in FIG. 5, semi-circular ribs 11L and 11R are installed in a protruding manner on the inner face of the above-described right and left half housings. Each of the ribs 11L and 11R is provided with a semi-circular cutout near the center in the longitudinal direction. The right and left half housings are assembled so that the ribs 11L and 11R are opposed to each other and a partition wall 15 having a through hole 14 in the center thereof is formed inside the body trunk portion 11. The inside of the body trunk portion 11 is partitioned in the front-rear direction with the partition wall 15 into the stator core 2 side in which a stator core 2 of the motor M is contained and the hammer case 20 side to which the hammer case 20 is assembled.

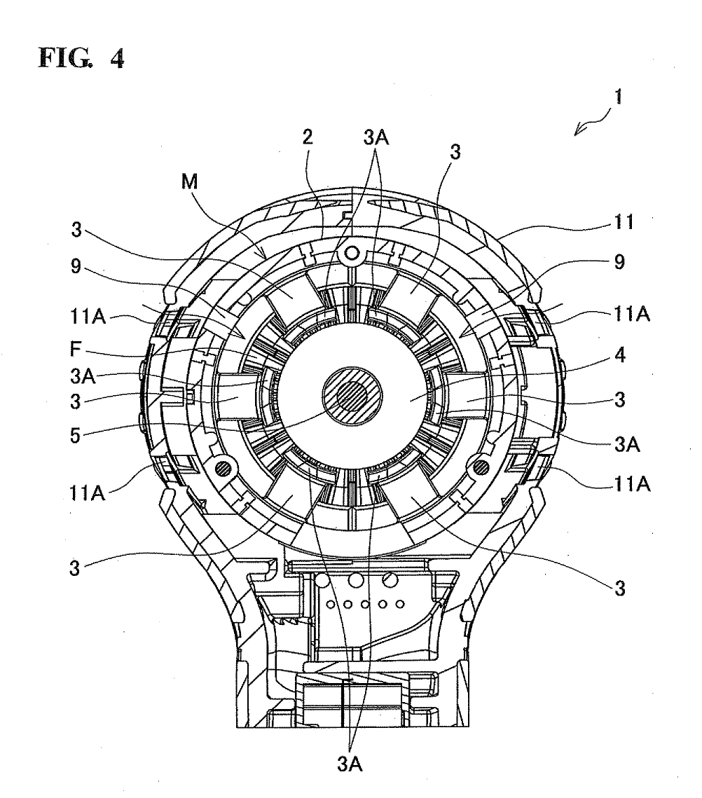

As shown in FIG. 1, FIG. 3, and FIG. 4, a plurality of air inlets 11A are provided on the right and left side faces of the body trunk portion 11. The air inlets 11A are used for introducing cooling air for the motor M into the body trunk portion 11. A plurality of air outlets 11B are provided in the rear of the air inlets 11A on the above-described right and left side faces to discharge the cooling air outside the body trunk portion 11. It should be noted that the body housing 10 is an example of housings according to the present invention.

As shown in FIG. 2 to FIG. 5, the motor M includes the stator core 2, a stator coil 3, and a rotor 4. The stator core 2 is substantially cylindrical and extends in the axial direction of the body trunk portion 11. As shown in FIG. 3 and FIG. 4, a plurality of stator coils 3 wrapping around coil winding members 3A that extend from the inner wall surface of the stator core 2 in the axial direction are disposed in the stator core 2 in the circumferential direction. An output shaft 5 of the motor M passes through the stator core 2 and a cylindrically shaped rotor 4 is supported by the output shaft 5 so as to face the stator coils 3.

As shown in FIG. 2, FIG. 3, and FIG. 5, an electric circuit board 7 that supplies electric current to each of the stator coils 3 to rotate the rotor 4 is screwed onto the front edge face of the stator core 2. The electric circuit board 7 has a through hole 8 (refer to FIG. 2). The front side of the stator core 2 is closed except for the through hole 8. The front end of the output shaft 5 of the motor M protrudes to the outside of the stator core 2 through the through hole 8. A fan F is fitted into the outer periphery face of the output shaft 5 on the rear end side of the output shaft 5. As shown in FIG. 4 and FIG. 5, air intakes 9, 9 are formed on the right and left sides of the stator core 2 in the rear of the electric circuit board 7 (left section of FIG. 5). Each air intake 9 is used for taking the cooling air introduced from each air inlet 11A to the inside of the body trunk portion 11 into the stator core 2. It should be noted that the electric circuit board 7 is an example of closing bodies according to the present invention.

As shown in FIG. 2, the handle portion 12 is provided in a linked manner with the body trunk portion 11 so as to be substantially T-shaped as viewed from the side of the impact driver 1. As shown in FIG. 2 and FIG. 5, a switch 12B having a trigger 12A is contained inside the handle portion 12. As shown in FIG. 1, FIG. 2, and FIG. 5, the battery pack attachment 13 is formed on the lower end of the handle portion 12 to which a battery pack B is removably attached. The battery pack B supplies power to the motor M when the trigger 12A is pressed into the handle portion 12 to turn on the switch 12B.

The hammer case 20 is made of a metal (aluminum, for example) shaped in a tubular bell shape and assembled to the front of the body trunk portion 11 (right direction of FIG. 2 and FIG. 3). As shown in FIG. 2 and FIG. 3, the hammer case 20 includes a tubular portion 21 having a small diameter on the front end thereof. Meanwhile, with an opening section on the rear end of the hammer case 20, a bearing box 22 shaped in a circular cap is integrated. The bearing box 22 includes a bearing portion 23 that protrudes in a ring shape toward the electric circuit board 7 located on the rear of the rear face of the bearing box 22. A ball bearing 24A is held by the bearing portion 23. As shown in FIG. 5, the bearing portion 23 enters the stator core 2 side through the through hole 14 on the partition wall 15. Furthermore, an insertion hole 25 for the output shaft 5 is provided on the rear end face of the bearing portion 23. The output shaft 5 of the motor M with a pinion 6 attached is inserted through the insertion hole 25 into the hammer case 20. The output shaft 5 passes through the partition wall 15 and is rotatably supported by the ball bearing 24A. A cover 30 is attached on the section exposed from the body trunk portion 11 on the front section of the outer periphery of the hammer case 20. A bumper 35 is assembled to the front end of the cover 30 to be attached on the exposed section. It should be noted that the bearing box 22 is an example of cover members according to the present invention and the ball bearing 24A is an example of bearings that rotatably support output shafts according to the present invention.

As shown in FIG. 2 and FIG. 3, a spindle 26 and an impact mechanism 40 are contained in the hammer case 20. A hollow portion 26A is formed on the rear end of the spindle 26. The spindle 26 is contained in the hammer case 20 coaxially with the hammer case 20. The outer periphery of the rear end of the spindle 26 is rotatably supported by a ball bearing 24B held in the bearing box 22. In the spindle 26, two planetary gears 28, 28 are rotatably supported on the front section of the ball bearing 24B in a point symmetric manner. Furthermore, the planetary gears 28, 28 mesh with an internal gear 27 held in the hammer ease 20. The planetary gears 28, 28 mesh with the pinion 6 exposed on the hollow portion 26A side and inserted into the hollow portion 26A.

The impact mechanism 40 includes a hammer 41, an anvil 42, and a coil spring 43. The hammer 41 is attached on the outside of the spindle 26 and on the front end of the inner periphery of the hammer 41, guide grooves 41A, 41A are formed each making a depression in the axial direction. By fitting the guide grooves 41A, 41A with balls 44, 44 fitted into cam grooves on the outer periphery of the spindle 26, the hammer 41 is coupled with the spindle 26 in an integrally rotatable and axially movable manner. The anvil 42 is rotatably supported by the tubular portion 21 coaxially with the hammer 41 on the front of the hummer 41. On the tip of the anvil 42, a chuck 42A to which a bit can be attached is provided. The coil spring 43 is fitted on the outer periphery of the spindle 26 to impel the hammer 41 to the advanced position where the hammer 41 is engaged with the anvil 42.

The impact mechanism 40 intermittently strikes the anvil 42 in the following manner. When the trigger 12A is pressed into the handle portion 12 to drive the motor M, the spindle 26 is rotated to rotate the anvil 42 through engagement with the hammer 41, enabling tightening of a screw with the bit attached on the anvil 42. When the screw fastening operation increases a load on the anvil 42, the balls 44, 44 recede along the cam grooves, and the hammer 41 recedes against the impellent force of the coil spring 43. Thus, the engagement of hammer 41 with the anvil 42 is unlocked. At the same time, the coil spring 43 impels the hammer 41 to rotate with the spindle 26 and advance to reengage with the anvil 42. With the above-described engagement and disengagement repeated, the anvil 42 receives intermittent strikes, enabling retightening of the screw.

As shown in FIG. 2, FIG. 3, and FIG. 5, on the outer periphery face of the bearing portion 23 that enters the stator core 2 side through the through hole 14 on the partition wall 15, the ring-shaped waterproof member 50 made of synthetic resin is fitted. When the output shaft 5 of the motor M is inserted into the hammer case 20 in the body trunk portion 11 and the motor M is coupled to the rear of the hammer case 20 as shown in FIG. 2 and FIG. 3, the electric circuit board 7 and the partition wall 15 are pressed to the waterproof member 50 fitted on the outer periphery face of the bearing portion 23 in the front-rear direction of the body trunk portion 11. Consequently, the waterproof member 50 closely contacts the electric circuit board 7 and the partition wall 15 with the output shaft 5 passing therethrough so that the gap between the electric circuit board 7 and the partition wall 15 in the front-rear direction is closed.

With the impact driver 1 according to the present invention, even if rainwater or the like enters inside the body housing 10 from the air inlet 11A (refer to FIG. 1, FIG. 3, and FIG. 4), for example, it is possible to prevent the rainwater or the like from entering inside the hammer case 20. More specifically, the rainwater or the like having entered from the air inlet 11A flows down to the handle portion 12 side through the body trunk portion 11, and further flows down between the electric circuit board 7 and the partition wall 15 to reach the waterproof member 50. At this time, because the gap between the electric circuit board 7 and the partition wall 15 is closed by the waterproof member 50 on the outer periphery face of the bearing portion 23, the rainwater or the like cannot enter the insertion hole 25 for the output shaft 5 of the motor M in the bearing box 22 between the electric circuit board 7 and the partition wall 15. This structure can prevent, for example, a rotation failure due to a trouble of the ball bearing 24A for the rotor 4 in the bearing box 22 and malfunction of the impact mechanism 40 contained in the hammer case 20.

Furthermore, in the present embodiment, when the fan F rotates with the rotation of the output shaft 5, the cooling air is introduced from the outside of the body housing 10 into the body trunk portion 11 through each air inlet 11A as shown by the solid arrows in FIG. 4, and thereafter, flows into the stator core 2 from each air intake 9. The cooling air is then circulated in the stator core 2 to be guided to the fan F. Thus, it is possible to cool the stator core 2 from inside with the cooling air. The cooling air introduced into the body trunk portion 11 from each air inlet 11A flows also between the stator core 2 and the inner face of the body trunk portion 11 to be guided to the fan F. Thus, it is also possible to cool the stator core 2 from outside with the cooling air. The cooling air guided to the fan F is discharged from each air outlet 11B between the blades of the fan F to the outside the body housing 10.

### <Effects of First Embodiment>

With the impact driver 1 in the present embodiment, the ring-shaped waterproof member 50 can prevent the rainwater or the like having entered inside the body trunk portion 11 from each air inlet 11A for the cooling air for the motor M from entering inside the hammer case 20 through the insertion hole 25 for the output shaft 5 of the motor M in the bearing box 22 between the electric circuit board 7 and the partition wall 15. Thus, it is possible to enhance the waterproof property of the hammer case 20.

It is possible to easily position the waterproof member 50 between the electric circuit board 7 and the partition wall 15 simply by fitting the waterproof member 50 on the outer periphery of the bearing portion 23 that protrudes toward the electric circuit board 7 from the rear face of the bearing box 22 and that enters the stator core 2 side through the partition wall 15.

Furthermore, because the front side of the stator core 2 is closed by the electric circuit board 7, a rational structure is enabled in which the electric circuit board 7 is also used as the closing body for closing the front side.

Also, even if the front edge face of the stator core 2 is closed by the electric circuit board 7, it is possible to cool the stator core 2 from inside with the cooling air taken into the stator core 2 from each air intake 9. Thus, the cooling effect of the motor M is enhanced.

### Second Embodiment

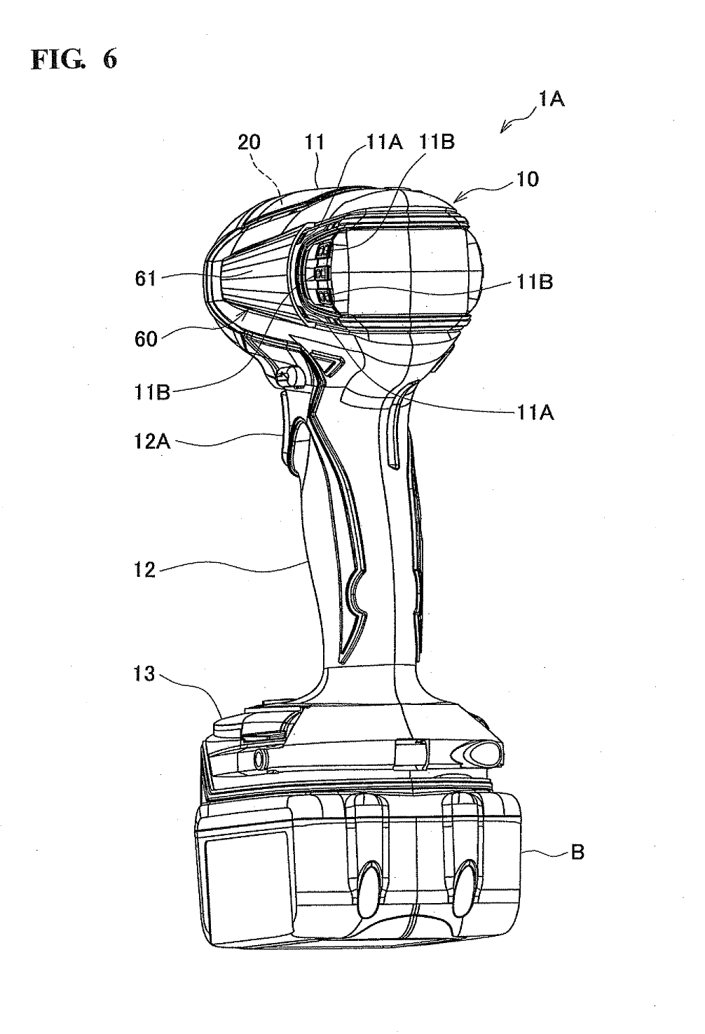

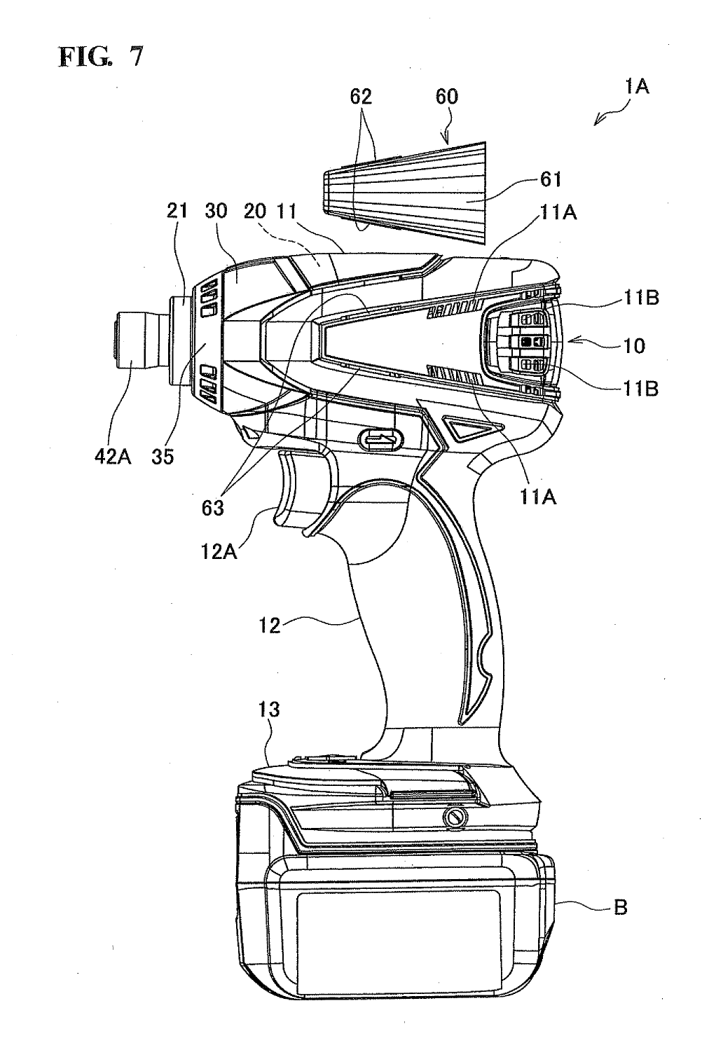

A second embodiment of the present invention will be described with reference to FIG. 6 and FIG. 7. Here, like numeral references denote like elements in the first embodiment, and detailed descriptions thereof are omitted. An impact driver 1A in the present embodiment includes an air inlet cover 60 that is attached to the body trunk portion 11 to cover each air inlet 11A from outside. The air inlet cover 60 includes a body portion 61 and engaging nail portions 62, 62. The body portion 61 has a cross section shape forming an arc-shaped curve along the periphery face of the body trunk portion 11, and has a substantially trapezoidal shape that is shorter on the front side than on the rear side as viewed from the front. The engaging nail portions 62, 62 have horizontally long shape and protrude from the upper end and the lower end of the body portion 61. On each of the right and left outer face of the body trunk portion 11, an engaging groove 63 (refer to FIG. 7) is provided so that the corresponding engaging nail portion 62 fits thereinto. As shown in FIG. 6, the air inlet cover 60 is attached to the body trunk portion 11 by fitting the engaging nail portions 62, 62 into the engaging grooves 63, 63, with a gap provided between the inner face of the air inlet cover 60 and each air inlet 11A.

### <Effects of Second Embodiment>

In the present embodiment, the air inlet cover 60 covers each air inlet 11A from outside. Thus, the air inlet cover 60 blocks rainwater or the like to prevent it from entering inside the body trunk portion 11A from each air inlet 11A. Even if the air inlet cover 60 is attached to the body trunk portion 11, the cooling air for the motor M can be introduced into the body trunk portion 11 from each air inlet 11A after entering from the outside of the body housing 10 and passing through the gap between the inner face of the air inlet cover 60 and each air inlet 11A. With conventional impact drivers, labels indicating product numbers or logo marks of the manufactures, for example, have been attached or the logo marks have been integrally formed in the region near the center of the body trunk portion 11 on the right and left outer surfaces that is interposed between the air inlets 11A. By contrast, the impact driver 1A in the present embodiment enables a label to be attached on and a logo mark to be formed integrally with the outer surface of each air inlet cover 60 that covers the air inlets 11A, for example. Therefore, a wider area can be used for attaching a label or integrally forming a logo mark than in conventional drivers, and thus, it is possible to display a product number or a logo mark with a larger size.

### Third Embodiment

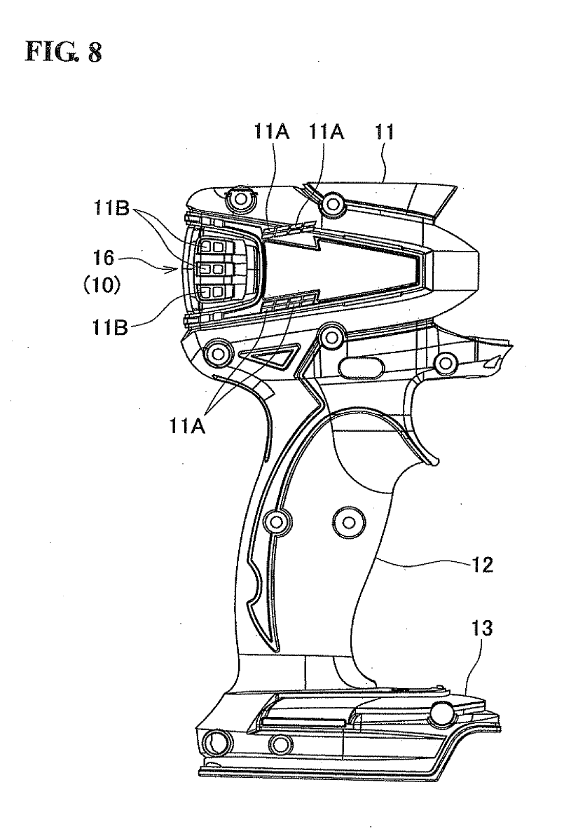

A third embodiment of the present invention will be described with reference to FIG. 8. Here, like numeral references denote like elements in the first and second embodiments, and detailed descriptions thereof are omitted. An impact driver according to the present embodiment includes a plurality of air inlets 11A on the side face of a half housing 16 constituting the body housing 10. The air inlets 11A are provided in a downwardly inclined manner toward a plurality of air outlets 11B provided in the rear of the body trunk portion 11 in the axial direction of the body trunk portion 11.

### <Effects of Third Embodiment>

In the present embodiment, because the air inlets 11A are provided in a downwardly inclined manner toward the air outlets 11B, rainwater or the like flows on the side face of the half housing 16 along the downward inclination. Thus, it is possible to prevent the rainwater or the like from entering inside the body trunk portion 11 from each air inlet 11A. Even if the rainwater or the like has entered inside the body trunk portion 11 from each air inlet 11A, the rainwater or the like can be easily guided to each air outlet 11B. In particular, impact tools such as impact drivers are often used in the posture such that a final axis such as an anvil is horizontal. Thus, the rainwater or the like can be easily drained outside the body trunk portion 11 from each air outlet 11B. Accordingly, it is possible to prevent an insulation failure of a motor M contained in the body trunk portion 11 due to the rainwater or the like, for example.

The present invention is not limited to the foregoing embodiments and can be carried out by appropriately modifying part of the configuration within a scope not departing from the spirit of the present invention. For example, the waterproof member may be made of an elastic material such as synthetic rubber unlike in the first to third embodiments described above. The electric circuit board 7 may be substituted with a synthetic resin plate or a plastic plate that is not equipped with an electric circuit to close the front side of the stator core 2. In the foregoing embodiments, the present invention is applied to a charging-type impact driver by way of example, although the present invention is not limited thereto. For example, the present invention may be applied to an alternate-current driven or charging-type soft impact driver.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. An impact tool, comprising:
a housing;
a motor contained in the housing, including a stator core provided with a stator coil,
a hammer case assembled in the front of the housing to receive an output shaft of the motor inserted therein;
a spindle which is installed in the hammer case and to which rotation is transmitted from the output shaft;
an impact mechanism installed in the hammer case and capable of converting output from the spindle into an intermittent striking operation;
a cover member through which the output shaft passes and that is integrally coupled with a rear end of the hammer case;
a partition wall through which the output shaft passes and that is installed in the housing to partition the stator core side and the hammer case side;
an air inlet for cooling air for the motor, the air inlet being provided on a side face of the housing;
a closing body provided on a front face of the stator core to close the front face with the output shaft passing therethrough; and
a ring-shaped waterproof member provided between the closing body and the partition wall to close a gap between the closing body and the partition wall with the output shaft passing therethrough.

2. The impact tool according to claim 1, wherein
a ring-shaped bearing portion is provided on a rear face of the cover member so as to protrude toward the closing body side and hold a bearing rotatably supporting the output shaft; and
the waterproof member is attached on the outer periphery of the bearing portion between the closing body and the partition wall.

3. The impact tool according to claim 1, wherein the closing body is an electric circuit board.

4. The impact tool according to claim 1, wherein an air intake is provided in the rear of the closing body in the stator core so that the cooling air introduced into the housing from the air inlet can be taken into the stator core.

5. The impact tool according to claim 2, wherein a though hole for the output shaft to pass through is provided on the partition wall, and the bearing portion enters the stator core side through the through hole.

6. The impact tool according to claim 1, wherein the waterproof member is made of synthetic resin.

7. The impact tool according to claim 1, wherein an air inlet cover is capable of being attached to the side face of the housing to cover the air inlet from outside.

8. The impact tool according to claim 7, wherein the air inlet cover is capable of being attached to the side face of the housing with a gap provided between an inner face of the air inlet cover and the air inlet.

9. The impact tool according to claim 7, wherein
the air inlet cover is provided with engaging nail portions protruding from an upper end and a lower end of the air inlet cover toward the housing side; and
the side face of the housing is provided with engaging grooves into which the corresponding engaging nail fits.

10. The impact tool according to claim 1, wherein
an air outlet for the cooling air is provided in the rear of the air inlet on the side face of the housing; and
the air inlet is provided on the side face in a downwardly inclined manner toward the air outlet.
